(19) United States
(12) Patent Application Publication
(10) Pub. No.: US 2026/0064291 A1
(43) Pub. Date: Mar. 5, 2026

(54) DATA STORAGE DEVICE AND METHOD OF OPERATING THE SAME

(71) Applicant: SAMSUNG ELECTRONICS CO., LTD., Suwon-si (KR)

(72) Inventors: Myungkyu LEE, Suwon-si (KR); Joon-Sung YANG, Seoul (KR); Jae-Youn HONG, Seoul (KR); Jinwoo SEONG, Suwon-si (KR)

(73) Assignees: SAMSUNG ELECTRONICS CO., LTD., Suwon-si (KR); UIF (University-Industry Foundation), Yonsei University, Seoul (KR)

(21) Appl. No.: 19/298,703

(22) Filed: Aug. 13, 2025

(30) Foreign Application Priority Data
Aug. 27, 2024 (KR) 10-2024-0115418
Oct. 16, 2024 (KR) 10-2024-0141497

(51) Int. Cl. G06F 3/06

(52) U.S. Cl. CPC G06F 3/0619; G06F 3/0659; G06F 3/0673

(57) ABSTRACT

A data storage device includes a memory device and a memory controller configured to control the memory device. The memory controller may include a compressor configured to perform a compression operation on at least one piece of input data, among a plurality of pieces of input data included in a weight bundle. The compressor may include a flag encoder configured to compress upper bits of each piece in the at least one piece of input data into a first flag, a first local counter configured to count a number of first flags and generates a first count value, and an index generator configured to generate an index for the weight bundle based on the first count value. The index may include information on a number of pieces of input data compressed using the first flag, among the plurality of pieces of the input data included in the weight bundle.

### CROSS-REFERENCE TO RELATED APPLICATION(S)

This U.S. non-provisional application claims priority under 35 USC § 119 to Korean Patent Application Nos. 10-2024-0115418, filed on Aug. 27, 2024, and 10-2024-0141497, filed on Oct. 16, 2024, in the Korean Intellectual Property Office, the disclosures of which are herein incorporated by reference in their entirety.

### BACKGROUND

Example embodiments relate to a data storage device and a method of operating the same.

Memory devices are used to store data and are classified into volatile and non-volatile memory devices. Volatile memory devices lose their stored data when their power supplies are interrupted. A dynamic random access memory (DRAM) device, a type of volatile memory device, is used in various applications such as mobile systems, servers, or graphic devices.

Recent research into on-device artificial intelligence (AI) has been actively pursued to perform AI computations, such as deep neural network (DNN) computations, on user devices such as mobile devices. Accordingly, data storage devices provided within user devices such as mobile devices also need to efficiently support AI computations.

### SUMMARY

Example embodiments provide a data storage device that is robust against errors and capable of efficiently supporting artificial intelligence (AI) computations.

According to an example embodiment, a data storage device includes a memory device including memory cells and a memory controller configured to control the memory device. The memory controller may include a compressor configured to perform a compression operation on at least one piece of input data, among a plurality of pieces of input data included in a weight bundle. The compressor may include a flag encoder configured to compress upper bits of each piece in the at least one piece of input data, among the plurality of pieces of the input data included in the weight bundle, into a first flag, a first local counter configured to count a number of first flags and generates a first count value, and an index generator configured to generate an index for the weight bundle based on the first count value. The index may include information on a number of pieces of input data compressed using the first flag, among the plurality of pieces of the input data included in the weight bundle.

According to an example embodiment, a memory controller controlling a memory device includes a flag encoder configured to compress upper bits of each piece in at least one piece of input data, among a plurality of pieces of input data included in a weight bundle, into a first flag, a first local counter configured to count a number of first flags and generates a first count value, and an index generator configured to generate an index for the weight bundle based on the first count value.

According to an example embodiment, a method of operating a data storage device includes compressing upper bits of each piece in at least one piece of input data, among a plurality of pieces of input data included in a weight bundle, into a first flag, connecting a second flag to each piece in at least one piece of input data, among the plurality of pieces of input data in the weight bundle, counting a number of first flags and generating a first count value, counting a number of second flags and generating a second count value, and generating an index comprising information on a number of pieces of input data compressed using the first flag, among the plurality of pieces of the input data included in the weight bundle, and information on a number of input data converted using the second flag, among the plurality of pieces of input data included in the weight bundle, based on the first count value and the second count value.

According to an example embodiment, a method of operating a data storage device includes compressing upper bits of each piece in at least one piece of input data, among a plurality of pieces of input data included in a weight bundle, into a first flag, connecting a second flag to each piece in at least one piece of input data, among the plurality of pieces of input data in the weight bundle excluding the at least one piece of input data that is compressed, if the number of the plurality of pieces of input data in the weight bundle is greater than the number of the at least one piece of input data that is compressed, counting a number of first flags and generating a first count value, counting a number of second flags and generating a second count value, and generating an index comprising information on a number of pieces of input data compressed using the first flag, among the plurality of pieces of the input data included in the weight bundle, and information on a number of input data converted using the second flag, among the plurality of pieces of input data included in the weight bundle, based on the first count value and the second count value.

### BRIEF DESCRIPTION OF DRAWINGS

FIG. 1 is a block diagram illustrating a data storage device according to example embodiments.

FIG. 2 is a block diagram illustrating an example of a memory device according to an example embodiment.

FIG. 3 is a diagram illustrating an example of a bank array according to an example embodiment.

FIGS. 4 and 5 are diagrams illustrating a flag generation operation according to an example embodiment.

FIGS. 6 and 7 are diagrams illustrating a decompression operation using a flag according to an example embodiment.

FIGS. 8 to 10 are diagrams illustrating an index generation operation according to an example embodiment.

FIG. 11 is a diagram illustrating an index checking operation according to an example embodiment.

FIG. 12 is a flowchart illustrating the operation of a data storage device according to an example embodiment.

FIGS. 13 to 17 are diagrams illustrating a header generation operation and a comparison operation using a header, according to an example embodiment.

FIG. 18 is a flowchart illustrating the operation of a data storage device according to an example embodiment.

### DETAILED DESCRIPTION

Hereinafter, example embodiments will be described with reference to the accompanying drawings.

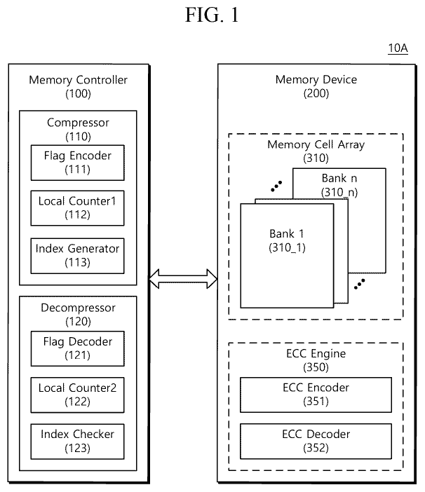

FIG. 1 is a block diagram illustrating a data storage device according to example embodiments.

A data storage device 10A according to example embodiments may not only perform a compression operation on artificial intelligence data such as DNN data but also perform a reliability protection operation on compressed data. Accordingly, the data storage device 10A may efficiently support artificial intelligence computations.

Referring to FIG. 1, the data storage device 10A may include a memory device 200 and a memory controller 100.

The memory device 200 may receive data from the memory controller 100 and store the received data. The memory device 200 may read the stored data in response to a request from the memory controller 100 and transmit the read data to the memory controller 100.

In an example embodiment, the memory device 200 may be a memory device including volatile memory cells. For example, the memory device 200 may be one of various DRAM devices such as a double data rate synchronous dynamic random access memory (DDR SDRAM) device, a DDR2 SDRAM device, a DDR3 SDRAM device, a DDR4 SDRAM device, a DDR5 SDRAM device, a DDR6 SDRAM device, a low power double data rate (LPDDR) SDRAM device, an LPDDR2 SDRAM device, an LPDDR3 SDRAM device, an LPDDR4 SDRAM device, an LPDDR4X SDRAM device, an LPDDR5 SDRAM device, a graphics double data rate synchronous graphics random access memory (GDDR SGRAM) device, a GDDR2 SGRAM device, a GDDR3 SGRAM device, a GDDR4 SGRAM device, a GDDR5 SGRAM device, or a GDDR6 SGRAM device.

In an example embodiment, the memory device 200 may be a stacked memory device in which DRAM dies are stacked, such as a high bandwidth memory (HBM) device, an HBM2 device, or an HBM3 device.

In an example embodiment, the memory device 200 may be a memory module such as a dual in-line memory module (DIMM). For example, the memory module 100A may be a registered DIMM (RDIMM), a load reduced DIMM (LRDIMM0, an unbuffered DIMM (UDIMM), a fully buffered DIMM (FB-DIMM), a small outline DIMM (SO-DIMM). However, this is only an example, and the memory device 200 may be another memory module such as a single in-line memory module (SIMM).

In an example embodiment, the memory device 200 may be an SRAM device, a NAND flash memory device, a NOR flash memory device, an RRAM device, an FRAM device, a PRAM device, a TRAM device, or an MRAM device.

For ease of description, an example is provided in which the memory device is an LPDDR SDRAM suitable for mounting on a mobile device.

The memory device 200 may include a memory cell array 310 and an ECC engine 350.

The memory cell array 310 may include a plurality of banks 310_1 to 310_n, and each bank may include memory cells for storing data. For ease of description, an example is provided in which each bank includes DRAM cells. However, this is only an example, and each of the plurality of banks 310_1 to 310_n may be implemented to include volatile memory cells other than DRAM cells. Alternatively, each of the plurality of banks 310_1 to 310_n may be implemented to include the same type of memory cells or different types of memory cells.

The ECC engine 350 may be provided to correct bit flip errors in data. For example, a memory device for a mobile device operates at a relatively low voltage, so that bit flip errors may occur relatively frequently in memory cells of the memory device for the mobile device. The ECC engine 350 may be provided to correct such bit flip errors.

In an example embodiment, the ECC engine 350 may be provided for each bank. However, this is only an example, and a plurality of banks may share a single ECC engine 350.

In an example embodiment, the ECC engine 350 may be configured such that its operation unit matches the unit of a write operation of the memory device 200. For example, the ECC engine 350 may be configured such that its operation unit is 64 bits, which matches the unit of the write operation. Accordingly, an operation of prefetching dummy data may be omitted.

For example, in general, the operation unit of the ECC engine may be 128 bits, and the unit of the write operation of the memory device may be 64 bits. The memory device receives 64-bit write data, so that additional 64-bit dummy data should be received through an internal read operation to enable the ECC engine to operate. Such an unnecessary prefetching operation of dummy data may increase power consumption, and the increase in power consumption may cause a decrease in the reliability of the memory cells. In addition, a read-modify-write (RMW) operation that consumes a large amount of power may be required to ensure the reliability of the memory cells.

In example embodiments, the ECC engine 350 may be configured such that its operation unit matches a write operation unit of the memory device 200. For example, the ECC engine 350 may be implemented using a single error correction and double error detection (SECDED) code that supports a 64-bit operation unit. Accordingly, an unnecessary prefetching operation of dummy data and an RMW operation may be omitted.

The ECC engine 350 may include an ECC encoder 351 and an ECC decoder 352.

The ECC encoder 351 may perform ECC encoding on data during a write operation. For example, the ECC encoder 351 may generate parity information and add the generated parity information to the data to generate a codeword during the ECC encoding.

The ECC engine 350 may perform ECC decoding on a codeword during a read operation. For example, the ECC decoder 352 may detect errors in the data using parity data and correct the detected errors during the ECC decoding.

The memory controller 100 may control the memory device 200. For example, the memory controller 100 may control the memory device 200 based on the requests from a processor supporting various applications such as server applications, personal computer (PC) applications, or mobile applications. For example, the memory controller 100 may include a processor and may control the memory device 200 based on requests from the processor.

The memory controller 100 may transmit commands and/or addresses to the memory device 200 to control the memory device 200. In addition, the memory controller 100 may transmit data to the memory device 200 or receive data from the memory device 200.

In an example embodiment, the memory controller 100 may perform a compression operation on artificial intelligence data such that artificial intelligence computation may be performed more easily in a user device such as a mobile device. The artificial intelligence data may refer to data applied to artificial intelligence computation such as DNN inference. For example, the artificial intelligence data may refer to data to which an INT8 quantization scheme is applied. For example, the artificial intelligence data may refer to a quantized INT8 weight value.

For example, artificial intelligence computation such as DNN inference requires a large amount of off-chip memory access. Therefore, the artificial intelligence data such as DNN data needs to be compressed to reduce its size and facilitate efficient artificial intelligence computation. In addition, data needs to be compressed to reduce its size and prevent generation of a parity bit associated with the above-described ECC operation and the resulting storage overhead. The memory controller 100 according to an example embodiment may compress upper bits of data into a small-sized flag based on a pattern and a frequency of occurrence of the upper bits to compress the data. Then, the memory controller 100 may combine the flag with the lower bits to generate compressed data. This will be described in more detail below.

In an example embodiment, the memory controller 100 may perform a reliability protection operation on the compressed data to ensure the reliability of the compressed data. For example, the memory controller 100 may generate an index in units of weight bundles based on the number of pieces of compressed data. A size of the weight bundle may be larger than a size of the compressed data. For example, the size of the weight bundle may be 64 bits, the size of the compressed data may be 5 bits and/or 10 bits, and the size of the index may be 4 bits. A 64-bit weight bundle may include at least one 5-bit compressed data, and/or at least one 10-bit uncompressed data, and a 4-bit index. This will be described in more detail below.

The memory controller 100 may include a compressor 110 and a decompressor 120.

The compressor 110 may include a flag encoder 111, a first local counter 112, and an index generator 113.

The flag encoder 111 may compress upper bits of artificial intelligence data into a small-sized flag based on a pattern and a frequency of occurrence of the upper bits. Then, the flag encoder 111 may combine a flag with lower bits to generate compressed data.

For example, the artificial intelligence data may include upper 5 bits and 3-bit lower bits. When the upper bits of the artificial intelligence data have a specific pattern, the flag encoder 111 may compress the upper 5 bits into a 2-bit flag and connect the 2-bit flag to the 3-bit lower bits. Accordingly, data compressed into 5 bits (hereinafter referred to as 5-bit compressed data) may be generated. The specific pattern of the upper bits may correspond to a range in which quantized weight values are concentrated.

Alternatively, the flag encoder 111 may generate only a flag without compressing the artificial intelligence data based on the pattern and the frequency of the artificial intelligence data. The flag encoder 111 may combine the flag with the artificial intelligence data to generate uncompressed data.

For example, when the upper bits of the artificial intelligence data do not have a specific pattern, the flag encoder 111 may generate a 2-bit flag and connect the 2-bit flag to 8-bit artificial intelligence data. Accordingly, data uncompressed into 10 bits (hereinafter referred to as 10-bit uncompressed data) may be generated. The upper bits may correspond to values that are outside the range in which the quantized weight values are concentrated.

The first local counter 112 may receive compressed data and/or uncompressed data from the flag encoder 111 and count the compressed data and/or the uncompressed data.

For example, the first local counter 112 may receive 5-bit compressed data and/or 10-bit uncompressed data from the flag encoder 111 and count the number of pieces of 5-bit compressed data and the number of pieces of 10-bit uncompressed data.

The index generator 113 may receive count values for the compressed data and/or the uncompressed data from the first local counter 112 and generate an index for each weight bundle based on the received count values. A size of the weight bundle may be set to be larger than a size of the compressed data.

For example, the index generator 113 may receive a first count value for the number of pieces of 5-bit compressed data and a second count value for the number of pieces of 10-bit uncompressed data from the first local counter 112. The index generator 113 may generate a 4-bit index based on the first count value and the second count value. The weight bundle may be set to 64 bits, and may include at least one 5-bit compressed data and/or at least one 10-bit uncompressed data and a 4-bit index.

The decompressor 120 may include a flag decoder 121, a second local counter 122, and an index verifier 123.

The flag decoder 121 may receive compressed data. The flag decoder 121 may perform a decompression operation of restoring the compressed data to original artificial intelligence data based on a flag of the compressed data.

For example, the flag decoder 121 may receive the 5-bit compressed data and restore the original artificial intelligence data based on a flag of the 5-bit compressed data.

In addition, the flag decoder 121 may receive uncompressed data. The flag decoder 121 may restore the uncompressed data to the original artificial intelligence data based on a flag of the uncompressed data.

For example, the flag decoder 121 may receive 10-bit uncompressed data. The flag decoder 121 may confirm that the 10-bit uncompressed data is uncompressed data, based on the flag of the 10-bit uncompressed data. The flag decoder 121 may restore the original artificial intelligence data by removing the flag from the 10-bit uncompressed data.

The second local counter 122 may count the number of pieces of compressed data based on the flag. For example, the second local counter 122 may receive a flag corresponding to the 5-bit compressed data and count the number of pieces of the 5-bit compressed data based on the flag. For example, the second local counter 122 may receive a flag corresponding to the 10-bit uncompressed data and count the number of pieces of the 10-bit uncompressed data based on the flag.

The index checker 123 may receive a count value for compressed data from the second local counter 122. In addition, the index checker 123 may receive an index. The index checker 123 may detect an error by comparing the count value for the compressed data with an expected count value included in the index.

For example, the index checker 123 may receive a first actual count value for the number of pieces of 5-bit compressed data and a second actual count value for the number of pieces of 10-bit uncompressed data from the second local counter 122. In addition, the index checker 123 may obtain a first expected count value for the number of pieces of 5-bit compressed data and a second expected count value for the number of pieces of 10-bit uncompressed data based on the index. The index checker 123 may compare the first actual count value with the first expected count value and compare the second actual count value with the second expected count value. When a mismatch is found, the index checker 123 may determine that an error has occurred.

As described above, the data storage device 10A according to an example embodiment may not only perform a compression operation on artificial intelligence data, such as DNN data, but also perform a reliability protection operation on the compressed data. Accordingly, the data storage device may efficiently support an artificial intelligence computation while being robust against errors.

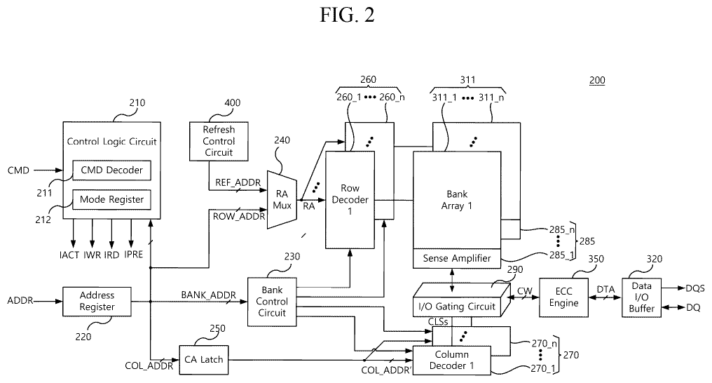

FIG. 2 is a block diagram illustrating an example of the memory device 200 according to an example embodiment. The memory device 200 of FIG. 2 may correspond to the memory device 200 of FIG. 1.

Referring to FIG. 2, the memory device 200 may include a control logic circuit 210, an address register 220, a bank control logic 230, a refresh control circuit 400, a row address multiplexer 240, a column address latch 250, a row decoder 260, a column decoder 270, a bank array group 311, a sense amplifier unit 285, an input/output gating circuit 290, an ECC engine 350, and a data input/output buffer 320.

The bank array group 311 may include a plurality of bank arrays 311_1 to 311_n. Each of the plurality of bank arrays 311_1 to 311_n may include a plurality of memory cells. For example, each of the plurality of memory cells may be formed at an intersection of a corresponding wordline and a corresponding bitline.

The row decoder 260 may include a plurality of sub-row decoders 260_1 to 260_n. Each of the plurality of sub-row decoders 260_1 to 260_n may be connected to a corresponding bank array, among the plurality of bank arrays 311_1 to 311_n.

The sense amplifier unit 285 may include a plurality of sense amplifiers 285_1 to 285_n. Each of the plurality of sense amplifiers 285_1 to 285_n may be connected to a corresponding bank array, among the plurality of bank arrays 311_1 to 311_n.

The column decoder 270 may include a plurality of sub-column decoders 270_1 to 270_n. Each of the plurality of sub-column decoders 270_1 to 270_n may be connected to a corresponding bank array, among the plurality of bank arrays 311_1 to 311_n, through a corresponding sense amplifier.

The plurality of bank arrays 311_1 to 311_n, the plurality of sense amplifiers 285_1 to 285_n, the plurality of column decoders 270_1 to 270_n, and the plurality of row decoders 260_1 to 260_n may each constitute a plurality of banks. For example, the first bank array 311_1, the first sense amplifier 285_1, the first column decoder 270_1, and the first row decoder 260_1 may constitute a first bank.

The address register 220 may receive an address ADDR, including a bank address BANK_ADDR, a row address ROW_ADDR, and a column address COL_ADDR, from the memory controller 100. The address register 220 may provide the received bank address BANK_ADDR to the bank control logic 230, the received row address ROW_ADDR to the row address multiplexer 240, and the received column address COL_ADDR to the column address latch 250. In addition, the address register 220 may provide the bank address BANK_ADDR and the row address ROW_ADDR to the row hammer management circuit.

The bank control logic 230 may generate bank control signals in response to the bank address BANK_ADDR. For example, a row decoder corresponding to the bank address BANK_ADDR, among the plurality of row decoders 260_1 to 260_n, may be activated in response to the bank control signals. A column decoder corresponding to the bank address BANK_ADDR, among the plurality of column decoders 270_1 to 270_n, may be activated in response to the bank control signals

The row address multiplexer 240 may receive a row address ROW_ADDR from the address register 220 and a refresh row address REF_ADDR from the refresh control circuit 400. The row address multiplexer 240 may selectively output the row address ROW_ADDR or the refresh row address REF_ADDR as a row address RA. The row address RA, output from the row address multiplexer 240, may be applied to each of the plurality of row decoders 260_1 to 260_n.

The refresh control circuit 400 may sequentially increment or decrement the refresh row address REF_ADDR in response to refresh signals from the control logic circuit 210, but this is only one example. In some embodiments, the memory device 200 may not perform a refresh operation, and the refresh control circuit 400 may not be provided.

Among the plurality of row decoders 260_1 to 260_n, a row decoder selected by the bank control logic 230 may activate a wordline corresponding to the row address RA output from the row address multiplexer 240. For example, the selected row decoder may apply a wordline driving voltage to a wordline corresponding to the row address.

The column address latch 250 may receive a column address COL_ADDR from the address register 220 and temporarily store the received column address COL_ADDR. For example, the column address latch 250 may increment the received column address COL_ADDR in burst mode. The column address latch 250 may apply the temporarily stored or incremented column address COL_ADDR′ to each of the plurality of column decoders 270_1 to 270_n.

Among the plurality of column decoders 270_1 to 270_n, a column decoder activated by the bank control logic 230 may activate a sense amplifier corresponding to the bank address BANK_ADDR and the column address COL_ADDR through the input/output gating circuit 290.

The input/output gating circuit 290 may include circuits for gating input/output data. In addition, the input/output gating circuit 290 may include data latches for storing codewords output from the plurality of bank arrays 311_1 to 311_n and write drivers for writing data in the plurality of bank arrays 311_1 to 311_n.

In an example embodiment, a codeword CW read from a selected bank array, among the plurality of bank arrays 311_1 to 311_n, may be detected by a sense amplifier corresponding to the selected bank array and stored in the data latches of the input/output gating circuit 290 during a read operation. In addition, the codeword CW stored in the data latches may be subjected to ECC decoding by the ECC engine 350 to be provided as data DTA to the data input/output buffer 320. The data input/output buffer 320 may generate a data signal DQ based on the data DTA and provide the data signal DQ together with a strobe signal DQS to the memory controller 100.

In an example embodiment, data DTA to be written in a selected bank array, among the plurality of bank arrays 311_1 to 311_n, may be received as a data signal DQ by the data input/output buffer 320 during a write operation. The data input/output buffer 320 may convert the data signal DQ into data DTA and provide the data DTA to the ECC engine 350. The ECC engine 350 may generate parity bits (or parity data) based on the data DTA and provide a codeword CW, including the data DTA and the parity bits, to the input/output gating circuit 290. The input/output gating circuit 290 may write the codeword CW in the selected bank array.

The data input/output buffer 320 may convert the data signal DQ into data DTA and provide the data DTA to the ECC engine 350 during a write operation. The data input/output buffer 320 may convert the data DTA, provided from the ECC engine 350, into a data signal DQ during a read operation.

The ECC engine 350 may perform ECC encoding on data DTA during a write operation. The ECC engine 350 may perform ECC decoding on the codeword CW during a read operation.

In addition, the ECC engine 350 may perform ECC encoding and ECC decoding on count data provided from the row hammer management circuit.

The control logic circuit 210 may control the operation of the memory device 200. For example, the control logic circuit 210 may generate control signals such that the memory device 200 performs a write operation and a read operation. The control logic circuit 210 may include a command decoder 211 for decoding a command CMD received from the memory controller 100 and a mode register set (MRS) 212 for setting the operation mode of the memory device 200.

The command decoder 211 may decode the command CMD to generate internal command signals such as an internal active signal IACT, an internal precharge signal IPRE, an internal read signal IRD, and an internal write signal IWR. In addition, the command decoder 211 may decode a chip select signal, a command/address signal, or the like, to generate control signals corresponding to the command CMD.

In an example embodiment, the ECC engine 350 may be configured such that its operation unit matches the unit of the write operation of the memory device 200. For example, the ECC engine 350 may be configured such that its operation unit matches 64 bits, which is the same as the unit of the write operation. For example, the ECC engine 350 may be implemented using a single error correction and double error detection (SECDED) code that supports the operation unit of 64 bits. Accordingly, a prefetching operations of unnecessary dummy data may be omitted, and an RMW operation may be significantly reduced or omitted.

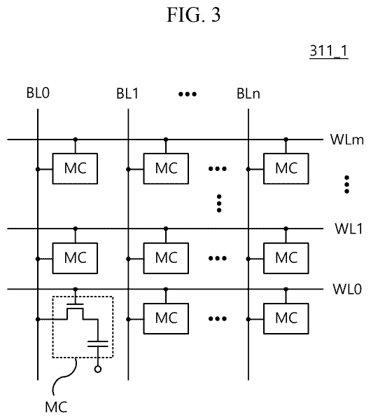

FIG. 3 is a diagram illustrating an example of a bank array according to an example embodiment. A bank array 311_1 of FIG. 3 may correspond to, for example, the first bank array 311_1 of FIG. 2.

Referring to FIG. 3, the first bank array 311_1 may include a plurality of wordlines WL0 to WLm, a plurality of bitlines BL0 to BLn, and a plurality of memory cells MC disposed at intersections between the wordlines WL0 to WLm and the bitlines BL0 to BLn.

In an example embodiment, each memory cell MC may be a DRAM cell. For example, each memory cell MC may include a cell transistor connected to a wordline and a bitline, and a cell capacitor connected to the cell transistor.

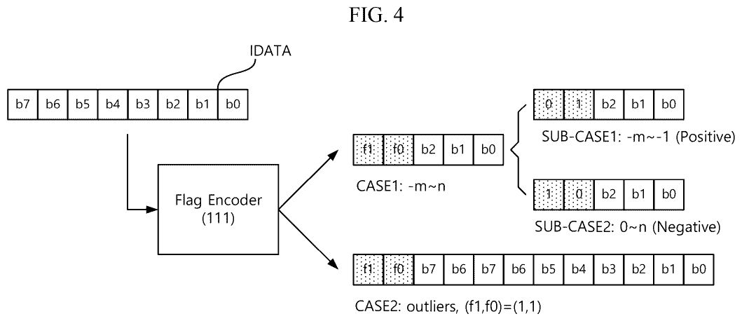

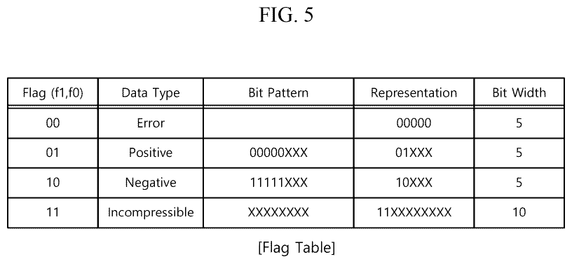

FIGS. 4 and 5 are diagrams illustrating a flag generation operation according to an example embodiment. FIG. 4 is a diagram illustrating an example in which the flag encoder 111 of FIG. 1 compresses artificial intelligence data, and FIG. 5 is a diagram illustrating an example of a flag table.

For ease of description, an example is provided in which input data is artificial intelligence data and the artificial intelligence data is data to which an INT8 quantization scheme is applied. Most the input data may be distributed within a predetermined range of absolute values depending on a DNN model. For example, most of the input data may have high weight values within a predetermined range. Hereinafter, an example is provided in which most of the input data is distributed between −8 and 7. Also, an example is provided in which the input data is 8-bit data. For upper 5 bits, ‘00000’ may represent a positive value of 0 to 7 within the range of −8 to 7, and ‘11111’ may represent a negative value of −8 to −1 within the range of −8 to 7.

Referring to FIGS. 4 and 5, the flag encoder 111 may receive input data IDATA. Upper 5 bits of the input data IDATA may be ‘b7 b6 b5 b4 b3,’ and lower 3 bits of the input data IDATA may be ‘b2 b1 b0.’

The flag encoder 111 may compress the upper bits into a small-sized flag based on a pattern and a frequency of occurrence of the upper bits of the input data.

For example, as in the first case CASE1, when the upper 5 bits of the input data IDATA are bit values indicating a range of −m to n corresponding to a high weight value, the flag encoder 111 may compress the upper 5 bits ‘b7 b6 b5 b4 b3’ into a 2-bit flag ‘f1 f0.’ Then, the flag encoder 111 may combine a flag with lower bits to generate compressed data.

For example, as in the first sub-case SUB-CASE1, when the upper 5 bits ‘b7 b6 b5 b4 b3’ is ‘11111’ representing a negative value of −m to −1, the flag encoder 111 may compress ‘11111’ into a flag of ‘10.’ Accordingly, 3 bits may be saved. Then, the flag encoder 111 may combine the flag ‘10’ with the lower bits ‘b2 b1 b0’ to generate 5-bit compressed data. Here, ‘−m’ may be ‘−8.’ However, this is only an example, and the value of ‘−m’ may vary depending on the DNN model.

For example, as in the second sub-case SUB-CASE2, when the upper 5 bits ‘b7 b6 b5 b4 b3’ is ‘00000’ representing a positive value of 0 to n, the flag encoder 111 may compress ‘00000’ into a flag of ‘01.’ Accordingly, 3 bits may be saved. Then, the flag encoder 111 may combine the flag ‘01’ with the lower bits ‘b2 b1 b0’ to generate 5-bit compressed data. Here, ‘n’ may be ‘7.’ However, this is only an example, and the value of ‘n’ may vary depending on the DNN model.

As in the second case CASE2, the upper 5 bits of the input data IDATA may have a bit value representing a value smaller than-m or a value larger than n. For example, the upper 5 bits of the input data IDATA may have a bit value other than ‘11111’ and ‘00000.’

In this case, the flag encoder 111 may not compress the input data IDATA and generate only a flag of ‘11.’ Then, the flag encoder 111 may combine the flag of ‘11’ with the input data IDATA ‘b7 b6 b5 b4 b3 b2 b1 b0’ to generate 10-bit uncompressed data.

Referring to FIG. 5, the memory controller 100 (see FIG. 1) may include a flag table for managing information indicated by the flag. The flag may include information on the data type, information on a bit pattern of the input data, information on the representation of the compressed data, and information on a bit width of the compressed data. For ease of description, in FIG. 5, ‘X’ may refer to an arbitrary bit value.

For example, a flag of ‘01’ may indicate that the input data has a positive data type, the upper bits of the input data are ‘00000,’ and a bit width is ‘5.’ The 5-bit compressed data may be represented as ‘01XXX.’

For example, a flag of ‘10’ may indicate that the input data has a negative data type, the upper bits of the input data are ‘11111,’ and the bit width is ‘5.’ The 5-bit compressed data may be represented as ‘10XXX.’

For example, a flag of ‘11’ may indicate that the input data has an incompressible data type, the upper bits of the input data are any bit value except ‘00000’ and ‘11111,’ and the bit width is ‘10.’ The 10-bit uncompressed data may be represented as ‘11XXXXXXXX.’

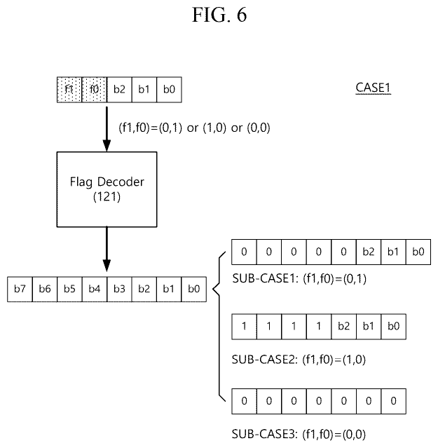

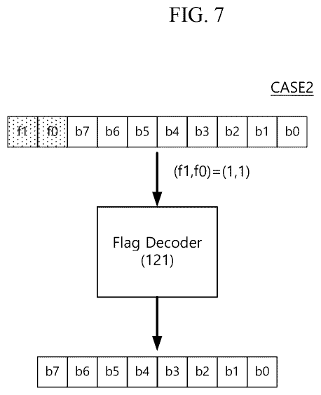

FIGS. 6 and 7 are diagrams illustrating a decompression operation using a flag according to an example embodiment. FIG. 6 is a diagram illustrating an example in which the flag decoder 121 of FIG. 1 decompresses 5-bit compressed data, and FIG. 7 is a diagram illustrating an example in which the flag decoder 121 processes 10-bit uncompressed data. A decoding operation in FIGS. 6 to 7 is opposite to the encoding operation in FIGS. 4 and 5. Therefore, redundant descriptions will be omitted to avoid repetition.

Referring to FIG. 6, in the first case CASE1, the flag decoder 121 may receive 5-bit compressed data. The flag decoder 121 may perform a decompression operation of restoring the 5-bit compressed data to original artificial intelligence data based on the flag of the 5-bit compressed data.

For example, as in the first sub-case SUB-CASE1, when the flag is ‘01,’ the flag decoder 121 may decompress the flag of ‘01’ into ‘00000.’ Then, the flag decoder 121 may combine ‘00000’ with the lower bits ‘b2 b1 b0.’ Accordingly, the original artificial intelligence data may be restored. For example, as in the second sub-case SUB-CASE2, when the flag is ‘10,’ the flag decoder 121 may decompress the flag of ‘10’ into ‘11111.’ Then, the flag decoder 121 may combine ‘11111’ with the lower bits ‘b2 b1 b0.’ Accordingly, the original artificial intelligence data may be restored.

For example, as in the third sub-case SUB-CASE3, when the flag is ‘00,’ the flag decoder 121 may determine that an error has occurred in the flag. For example, referring to the flag table of FIG. 4, ‘00’ may be predefined as an error.

In this case, the likelihood of a single bit flip error occurring in ‘01’ and ‘10’ is higher than the likelihood of a double bit flip error occurring in ‘11.’ Therefore, the memory controller 100 may interpret the data including the flag for ‘00’ as 5-bit wide data. In addition, the flag decoder 121 may define the data as ‘,’ rather than connecting to lower 3 bits ‘b2 b1 b0,’ to significantly reduce the effect of errors.

As in the second case CASE2, the flag decoder 121 may receive 10-bit uncompressed data. The flag decoder 121 may perform a decompression operation of restoring the 10-bit uncompressed data to the original artificial intelligence data based on the flag of the 10-bit uncompressed data.

For example, when the flag is ‘11,’ the flag decoder 121 may restore the original artificial intelligence data by removing the flag from the 10-bit uncompressed data.

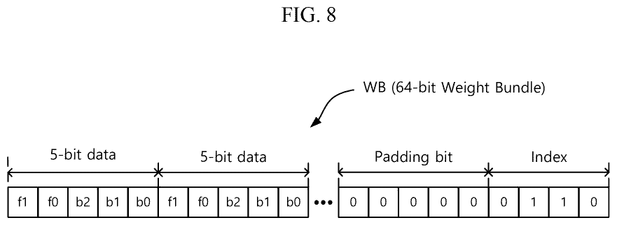

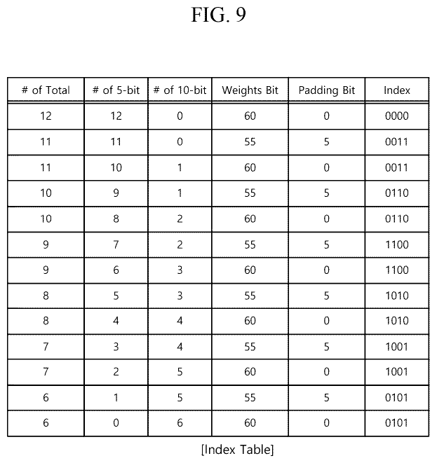

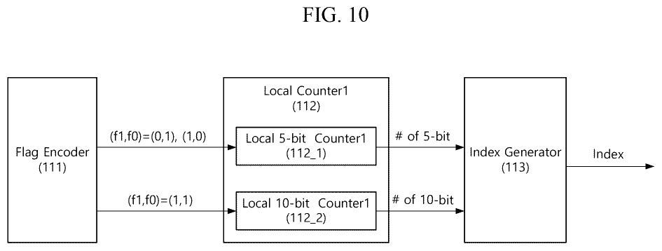

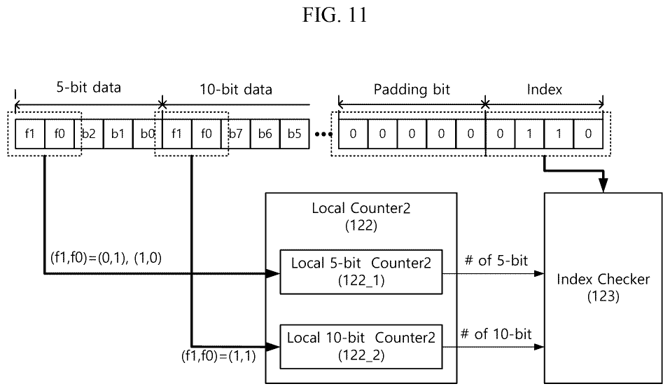

FIGS. 8 to 10 are diagrams illustrating an index generation operation according to an example embodiment. FIG. 11 is a diagram illustrating an index checking operation according to an example embodiment. FIG. 8 is a diagram illustrating an example of a weight bundle, FIG. 9 is a diagram illustrating an example of an index table, and FIG. 10 is a diagram illustrating an example in which the first local counter 112 and the index generator 113 of FIG. 1 generate an index. FIG. 11 is a diagram illustrating an example in which the second local counter 122 and the index checker 123 of FIG. 1 compare an actual count value with an expected count value.

For ease of description, an example is provided in which a compression operation and a decompression operation using a flag are similar to those in FIGS. 4 to 7. Also, an example is provided in which a size of the weight bundle is 64 bits.

As described above, the compression operation using the flag may reduce a storage overhead. Considering the susceptibility of cells of a memory device for mobile devices to leakage, the performance of error detection and data restoration for compressed data need to be improved.

Referring to FIG. 8, the memory controller 100 may define a weight bundle WB having a predetermined size to improve the perform of error detection and data restoration for the compressed data. The weight bundle WB may include at least one piece of compressed data and an index. For example, a 64-bit weight bundle WB may include at least one piece of 5-bit compressed data and/or 10-bit uncompressed data and an index. Optionally, the 64-bit weight bundle WB may include padding bits.

Referring to FIG. 9, the memory controller 100 may include an index table for managing information indicated by the index. The index may include information on the number of pieces of 5-bit compressed data, information on the number of the pieces of 10-bit uncompressed data, information on the total number of pieces of data, and information on data bits. In addition, each bundle includes padding bits, and different padding bits may correspond to a single index.

For example, an index of ‘0000’ may indicate that the number of the pieces of 5-bit compressed data is 12, the number of the pieces of 10-bit uncompressed data is 0, the total number of pieces of data is 12, and the number of bits of data is 60 bits.

For example, an index of ‘0011’ and the corresponding ‘5’ padding bits (for example, ‘11111’) may indicate that the number of 5-bit compressed data is 11, the number of 10-bit uncompressed data is 0, the total number of data is 11, and the number of bits of the data is 55.

For example, an index of ‘0011’ and its corresponding padding bit of ‘0’ (for example, ‘00000’) may indicate that the number of pieces of 5-bit compressed data is 10, the number of pieces of 10-bit uncompressed data is 1, the total number of pieces of data is 11, and the number of bits of the data is 60.

In this manner, the index may include information on the number of pieces of 5-bit compressed data, information on the number of 10-bit uncompressed data, information on the total number of pieces of data, and information on the number of bits of the data.

Referring to FIG. 10, the compressor 110 (see FIG. 1) of the memory controller 100 may generate an index for each weight bundle WB during a compression process. Each weight bundle WB may include an index, and the index may include information on the number of pieces of 5-bit compressed data and information on the number of pieces of 10-bit uncompressed data.

For example, the first local counter 112 may include a first local 5-bit counter 112_1 and a first local 10-bit counter 112_2. According to example embodiments, the first local 5-bit counter 112_1 and the first local 10-bit counter 112_2 may be referred to as a first sub-local counter and a second sub-local counter, respectively.

The first local 5-bit counter 112_1 may receive a flag of ‘01’ or ‘10’ from the flag encoder 111. The first local 5-bit counter 112_1 may determine the received flag as 5-bit compressed data and count the number of pieces of the 5-bit compressed data.

The first local 10-bit counter 112_2 may receive a flag of ‘11’ from the flag encoder 111. The first local 10-bit counter 112_2 may determine the received flag as 10-bit uncompressed data and count the number of pieces of the 10-bit uncompressed data.

The index generator 113 may receive information on the number of the pieces of 5-bit compressed data and the number of the pieces of 10-bit uncompressed data from the first local counter 112. For example, when data of a size corresponding to a single bundle, such as 55 bits or 60 bits, is received, the index generator 113 may generate an index based on the information on the number of the 5-bit compressed data and the number of the pieces of 10-bit uncompressed data from the first local counter 112. Padding bits may be selectively generated to fix a size of the bundle excluding the index to 60 bits.

Referring to FIG. 11, the decompressor 120 (see FIG. 1) of the memory controller 100 may receive a weight bundle WB during a decompression process. The decompressor 120 may count the number of pieces of 5-bit compressed data and the number of pieces of 10-bit uncompressed data included in the weight bundle WB. The number of the pieces of 5-bit compressed data and the number of the pieces of 10-bit uncompressed data counted during the decompression process may be referred to as a first actual count value and a second actual count value, respectively. Then, the decompressor 120 may extract the number of the pieces of 5-bit compressed data and the number of the pieces of 10-bit uncompressed data from the index. The number of the pieces of 5-bit compressed data and the number of the pieces of 10-bit uncompressed data extracted from the index may be referred to as a first expected count value and a second expected count value, respectively. The decompressor 120 may compare the first actual count value with the first expected count value and compare the second actual count value with the second expected count value. When a mismatch is found, the index checker 123 may determine that an error has occurred.

For example, the second local counter 122 may include a second local 5-bit counter 122_1 and a second local 10-bit counter 122_2. According to example embodiments, the second local 5-bit counter 122_1 and the second local 10-bit counter 122_2 may be referred to as a third sub-local counter and a fourth sub-local counter, respectively.

The second local 5-bit counter 122_1 may extract a flag of ‘01’ or ‘10’ from the weight bundle WB. The second local 5-bit counter 122_1 may determine the flag of ‘01’ or ‘10’ as 5-bit compressed data and count the number of pieces of 5-bit compressed data. Accordingly, the first actual count value may be generated.

The second local 10-bit counter 122_2 may receive a flag of ‘11’ from the weight bundle WB. The second local 10-bit counter 122_2 may determine the flag of ‘11’ as 10-bit uncompressed data and count the number of pieces of 10-bit uncompressed data. Accordingly, the second actual count value may be generated.

The index checker 123 may receive an index from the weight bundle WB. In addition, the index checker 123 may selectively receive padding bits from the weight bundle WB. Then, the index checker 123 may extract a first expected count value for the number of pieces of 5-bit compressed data and a second expected count value for the number of pieces of 10-bit uncompressed data from the index and the padding bits.

For example, when the index is ‘0110’ and the padding bit is ‘0,’ the index checker 123 may extract ‘8’ as the first expected count value and ‘2’ as the second expected count value based on the index table of FIG. 9.

The first local counter 112 may receive information on the number of the pieces of 5-bit compressed data and the number of the pieces of 10-bit uncompressed data. For example, when data of a size corresponding to a single bundle, such as 55 bits or 60 bits, is received, the index generator 113 may generate an index based on the information on the number of the pieces of 5-bit compressed data and the number of the pieces of 10-bit uncompressed data from the first local counter 112. Padding bits may be selectively generated to fix the size of the bundle excluding the index to 60 bits.

Then, the index checker 123 may compare the first actual count value with the first expected count value and compare the second actual count value with the second expected count value. When a mismatch is found, the index checker 123 may determine that an error has occurred. The memory controller 100 may transmit a rollback signal to the memory device 200. The memory device 200 may retransmit the weight bundle to the memory device 200 in response to the rollback signal.

As described above, the data storage device 10A according to an example embodiment may not only perform a compression operation on artificial intelligence data such as DNN data but also perform a reliability protection operation on the compressed data. Accordingly, the data storage device may efficiently support artificial intelligence computations.

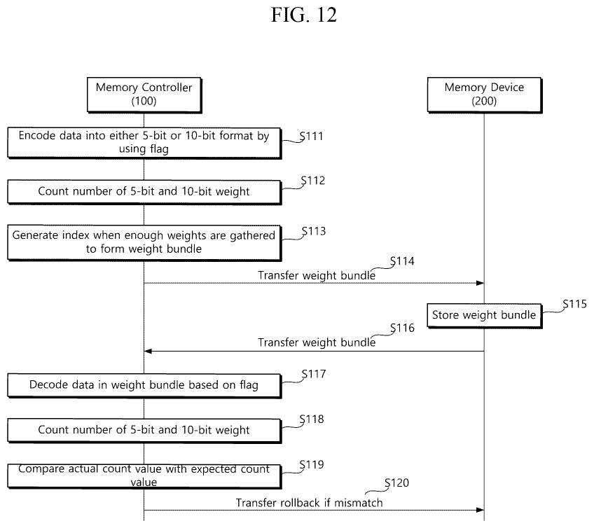

FIG. 12 is a flowchart illustrating the operation of the data storage device according to an example embodiment. The data storage device of FIG. 12 may correspond to the data storage device 10A of FIG. 1.

Referring to FIG. 12, a write operation may be performed first. In operation S111, the memory controller 100 may encode data into either a 5-bit format or 10-bit format using a flag. For example, the memory controller 100 may encode artificial intelligence data into 5-bit compressed data or 10-bit uncompressed data using a flag.

In operation S112, the memory controller 100 may perform a counting operation on 5-bit weights and 10-bit weights. The 5-bit weight may correspond to 5-bit compressed data, and the 10-bit weight may correspond to 10-bit uncompressed data.

In operation S113, when sufficient weights are collected to form a weight bundle, the memory controller may generate an index. For example, the index may include information on the number of the 5-bit weights and information on the number of the 10-bit weights.

In operation S114, the memory controller 100 may transmit the weight bundle to the memory device 200.

In operation S115, the memory device 200 may store the weight bundle. For example, the memory device 200 may store the weight bundle using an ECC encoding operation.

Then, a read operation may be performed.

In operation S116, the memory device 200 may transmit the weight bundle to the memory controller 100. For example, the memory device 200 may read the weight bundle using an ECC decoding operation and transmit the read weight bundle to the memory controller 100.

In operation S117, the memory controller 100 may perform a decoding operation on data included in the weight bundle based on a flag. For example, the memory controller 100 may restore the 5-bit compressed data and/or 10-bit uncompressed data to the original artificial intelligence data based on the flag.

In operation S118, the memory controller 100 may perform a counting operation on the data included in the weight bundle. For example, the memory controller 100 may perform a counting operation on the 5-bit weights and the 10-bit weights. Accordingly, the first actual count value and the second actual count value may be generated.

In operation S119, the memory controller 100 may compare the actual count value with an expected count value. For example, the memory controller 100 may extract a first expected count value for the 5-bit weight and a second expected count value for the 10-bit weight from the index. The memory controller 100 may compare the first actual count value with the first expected count value and compare the second actual count value with the second expected count value.

In operation S120, when a mismatch occurs between the count values, the memory controller 100 may transmit a rollback signal to the memory device 200.

As described above, the data storage device 10A according to an example embodiment may not only perform a compression operation on artificial intelligence data such as DNN data but also perform a reliability protection operation on the compressed data. Accordingly, the data storage device may efficiently support artificial intelligence computations.

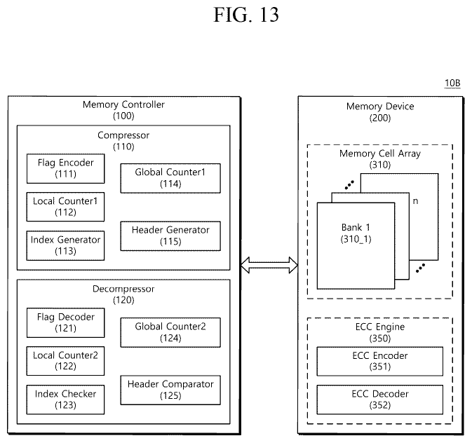

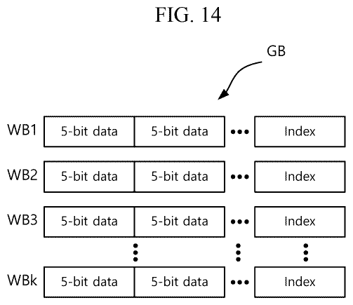

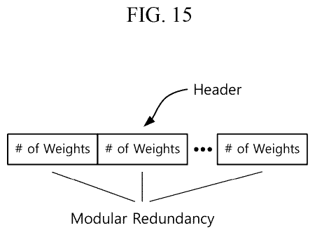

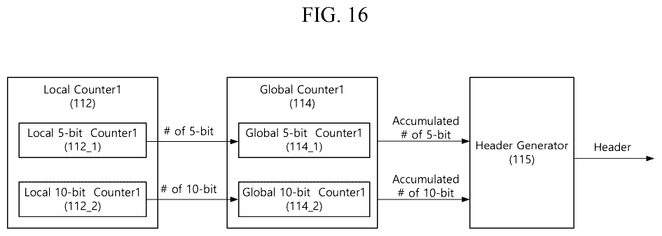

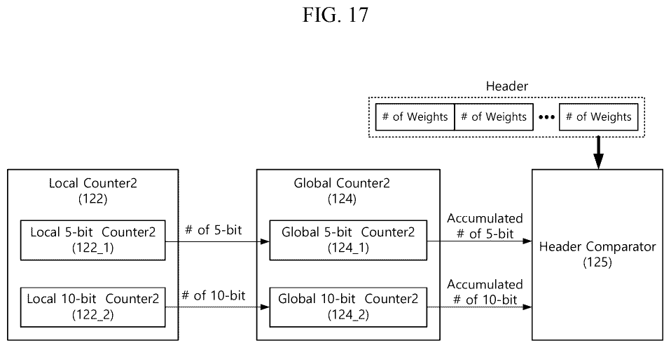

FIGS. 13 to 17 are diagrams illustrating a header generation operation and a comparison operation using a header, according to an example embodiment. FIG. 13 is a diagram illustrating an example of a data storage device according to an example embodiment. FIG. 14 is a diagram illustrating an example of a global block according to an example embodiment. FIG. 15 is a diagram illustrating an example of a header according to an example embodiment. FIG. 16 is a diagram illustrating an example of a header generation operation according to an example embodiment. FIG. 17 is a diagram illustrating an example of a comparison operation using a header according to an example embodiment.

The configuration and operation of the data storage device 10B of FIGS. 13 to 17 are similar to those of the data storage device 10A described in FIGS. 1 to 12. Therefore, redundant descriptions will be omitted to avoid repetition.

In FIGS. 1 to 12, the data storage device 10A has been described as performing the compression operation using the flag and the reliability protection operation using the index. However, this is only an example, and example embodiments are not limited thereto. The data storage device 10B according to an example embodiment may perform an additional reliability protection operation using a header.

For example, errors may occur in both a flag and an index. The weight bundle with an error may be determined to be normal, and such undetected errors may cause continuous mapping errors in subsequent decoding processes.

Referring to FIGS. 13 to 17, a data storage device 10B according to an example embodiment may define a global block to ensure reliability even when errors occur in both a flag and an index. The data storage device 10B may accumulate and store count values for a plurality of weight bundles included in the global block, and may perform additional error verification operations based on count values accumulated in units of global blocks.

In an example embodiment, a global block GB may be defined to include a plurality of weight bundles WB1 to WBk, as illustrated in FIG. 14. For example, a single global block GB may include 100 weight bundles WB. However, this is only an example, and the number of weight bundles included in the global block GB may vary according to example embodiments.

A single header may be allocated to a single global block. The header may include, for example, information on the number of pieces of 5-bit compressed data corresponding to a single global block, and information on the number of pieces of 10-bit uncompressed data corresponding to the single global block.

In an example embodiment, a modular redundancy (MR) technique may be applied to prevent the loss of data stored in the header, as illustrated in FIG. 15. For example, a triple modular redundancy (TMR) technique may be applied to prevent the loss of data stored in the header. A total of three headers may be provided to store the same information

Referring to FIGS. 13 and 16, the compressor 110 of the memory controller 100 may further include a first global counter 114 and a header generator 115. The first global counter 114 may include a first global 5-bit counter 114_1 and a first global 10-bit counter 114_2. According to example embodiments, the first global 5-bit counter 114_1 and the first global 10-bit counter 114_2 may be referred to as a first sub-global counter and a second sub-global counter, respectively.

The first global counter 114 may receive information on the number of pieces of compressed data and/or uncompressed data from the first local counter 112 during compression. The first global counter 114 may accumulate and count the number of pieces of data compressed and/or data uncompressed in units of global blocks.

For example, the first global 5-bit counter 114_1 of the first global counter 114 may receive first count values for the number of the pieces of 5-bit compressed data for weight bundles belonging to the global block from the first local 5-bit counter 112_1 of the first local counter 112, and accumulate and store the received the first count values during the compression. Accordingly, a first global count value corresponding to a single global block may be generated. The first global count value may refer to an accumulated value of first count values for 5-bit compressed data corresponding to the single global block.

In addition, for example, the first global 10-bit counter 114_2 of the first global counter 114 may receive second count values for the number of 10-bit uncompressed data for weight bundles belonging to the global block from the first local 10-bit counter 112_2 of the first local counter 112, and accumulate and store the received second count values during the compression. Accordingly, a second global count value corresponding to a single global block may be generated. The second global count value may refer to an accumulated value of second count values for 10-bit uncompressed data corresponding to the single global block.

The header generator 115 may receive accumulated information on the number of the pieces of data compressed and/or data uncompressed in units of global blocks during the compression, and may generate a header based on the received information.

For example, the header generator 115 may receive a first global count value for the 5-bit compressed data from the first global 5-bit counter 114_1 of the first global counter 114. Also, the header generator 115 may receive a second global count value for the 10-bit compressed data from the first global 10-bit counter 114_2 of the first global counter 114. The header generator 115 may generate a header based on the first global count value, which is information on the total number of pieces of 5-bit compressed data included in one global block, and the second global count value, which is information on the total number of pieces of 10-bit compressed data.

Continuing to refer to FIGS. 13 and 17, the decompressor 120 of the memory controller 100 may further include a second global counter 124 and a header comparator 125. The second global counter 124 may include a second global 5-bit counter 124_1 and a second global 10-bit counter 124_2. According to example embodiments, the second global 5-bit counter 124_1 and the second global 10-bit counter 124_2 may be referred to as a third sub-global counter and a fourth sub-global counter, respectively.

The second global counter 124 may receive information on the actual number of pieces of compressed data and/or uncompressed data from the second local counter 122 during decompression. The second global counter 124 may accumulate information on the number of pieces of data compressed and/or data uncompressed in units of global blocks and generate an actual global count value.

For example, the second global 5-bit counter 124_1 of the second global counter 124 may receive a first actual count value, which is information on the number of 5-bit compressed data belonging to one weight bundle, from the second local 5-bit counter 122_1 of the second local counter 122, and accumulate the received first actual count value during the decompression. Accordingly, a first actual global count value corresponding to a single global block may be generated.

In addition, for example, the second global 10-bit counter 124_2 of the second global counter 124 may receive second actual count values, which are information on the number of 10-bit compressed data belonging to one weight bundle, from the second local 10-bit counter 122_2 of the second local counter 122, and accumulate the received second actual count values during the decompression. Accordingly, a second actual global count value corresponding to the single global block may be generated.

The header comparator 125 may receive an actual global count value for the compressed data corresponding to the single global block from the second global counter 124. Also, the header comparator 125 may receive a header. The header comparator 125 may compare the actual global count value for the compressed data with an expected global count value extracted from the header to detect errors.

For example, the header comparator 125 may receive a first actual global count value, which is the total number of pieces of 5-bit compressed data corresponding to the single global block, and a second actual global count value, which is the total number of pieces of 10-bit compressed data, from the second global counter 124. Also, the header comparator 125 may obtain a first expected global count value, which is the total number of pieces of 5-bit compressed data corresponding to the single global block, and a second expected global count value, which is the total number of pieces of 10-bit uncompressed data, based on the header. The header comparator 125 may compare the first actual global count value with the first expected global count value and compare the second actual global count value with the second expected global count value. When a mismatch is found, the header comparator 125 may determine that an error has occurred.

As described above, the data storage device 10B according to an example embodiment may accumulate and store count values for a plurality of weight bundles included in a global block, and may perform an additional error verification operation based on count values accumulated in units of global blocks.

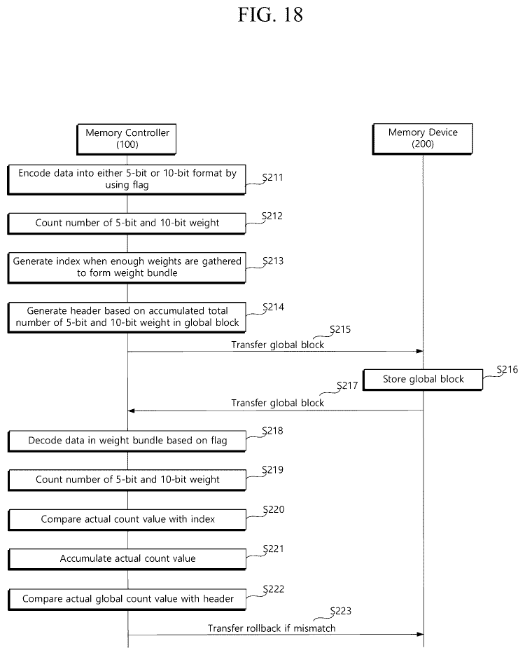

FIG. 18 is a flowchart illustrating the operation of a data storage device according to an example embodiment. The data storage device of FIG. 18 may correspond to the data storage device 10B of FIG. 13.

Referring to FIG. 18, a write operation may be performed first.

In operation S211, the memory controller 100 may encode data into either a 5-bit or 10-bit format using a flag. For example, the memory controller 100 may encode artificial intelligence data into 5-bit compressed data or 10-bit uncompressed data using a flag.

In operation S212, the memory controller 100 may perform a counting operation on 5-bit weights and 10-bit weights. The 5-bit weight may correspond to 5-bit compressed data, and the 10-bit weight may correspond to 10-bit uncompressed data.

In operation S213, when sufficient weights are collected to form a weight bundle, the memory controller 100 may generate an index. For example, the index may include information on the number of the 5-bit weights and information on the number of the 10-bit weights.

In operation S214, when sufficient weight bundles are collected to form a global block, the memory controller 100 may generate a header. For example, the memory controller 100 may generate a header by accumulating 5-bit weights and 10-bit weights in units of global blocks.

In operation S215, the memory controller 100 may transmit the global block to the memory device 200.

In operation S216, the memory device 200 may store the global block. For example, the memory device 200 may store the global block using an ECC encoding operation.

Then, a read operation may be performed.

In operation S217, the memory device 200 may transmit the global block to the memory controller 100. For example, the memory device 200 may read the data included in the global block using an ECC decoding operation and transmit the read data to the memory controller 100.

In operation S218, the memory controller 100 may perform a decoding operation on the data included in the weight bundle based on a flag. For example, the memory controller 100 may restore the 5-bit compressed data and/or the 10-bit uncompressed data to original artificial intelligence data based on the flag.

In operation S218, the memory controller 100 may perform a counting operation on the data included in the weight bundle. For example, the memory controller 100 may perform a counting operation on the 5-bit weights and the 10-bit weights. Accordingly, the first actual count value and the second actual count value may be generated.

In operation S220, the memory controller 100 may compare an actual count value with an expected count value. For example, the memory controller 100 may extract a first expected count value for 5-bit weights and a second expected count value for 10-bit weights from the index. The memory controller 100 may compare the first actual count value with the first expected count value and compare the second actual count value with the second expected count value.

In operation S221, the memory controller 100 may accumulate the actual count values. For example, the memory controller 100 may accumulate first actual count values for 5-bit weights to generate a first actual global count value. The memory controller 100 may accumulate second actual count values for 10-bit weights to generate a second actual global count value.

In operation S222, the memory controller 100 may compare the actual global count value with an expected global count value extracted from the header. For example, the memory controller 100 may extract the first expected global count value for 5-bit weights and the second expected count value for 10-bit weights from the header. The memory controller 100 may compare the first actual global count value with the first expected global count value and compare the second actual global count value with the second expected global count value.

In operation S223, when a mismatch occurs between the global count values and/or the count values, the memory controller 100 may transmit a rollback signal to the memory device 200.

As described above, the data storage device 10B according to an example embodiment may not only perform a compression operation on artificial intelligence data, such as DNN data, but also perform a reliability protection operation on the compressed data. For example, the data storage device 10B may perform an error verification using a header as well as an index to further ensure reliability.

As set forth above, a data storage device according to example embodiments is robust against errors and capable of efficiently supporting artificial intelligence (AI) computations.

While example embodiments have been shown and described above, it will be apparent to those skilled in the art that modifications and variations could be made without departing from the scope of the present inventive concept as defined by the appended claims.

What is claimed is:

1. A data storage device comprising:
a memory device comprising memory cells; and
a memory controller configured to control the memory device,
wherein
the memory controller comprises:
a compressor configured to perform a compression operation on at least one piece of input data, among a plurality of pieces of input data included in a weight bundle,
the compressor comprises:
a flag encoder configured to compress upper bits of each piece in the at least one piece of input data, among the plurality of pieces of the input data included in the weight bundle, into a first flag;
a first local counter configured to count a number of first flags and generates a first count value; and
an index generator configured to generate an index for the weight bundle based on the first count value,
wherein the index comprises information on a number of pieces of input data compressed using the first flag, among the plurality of pieces of the input data included in the weight bundle.

2. The data storage device of claim 1, wherein
the flag encoder compresses upper bits of first input data, among the plurality of pieces of the input data, into the first flag, and then combines the first flag with lower bits of the first input data to generate first compressed data.

3. The data storage device of claim 2, wherein
the flag encoder generates a second flag corresponding to second input data, among the plurality of pieces of the input data, and then combines the second flag with the second input data to generate second data, and
upper bits of the first input data correspond to a predetermined range, and the upper bits of the second input data are outside the predetermined range.

4. The data storage device of claim 3, wherein
the first local counter comprises:
a first sub-local counter configured to count the first flag and generate the first count value for a number of pieces of data associated with the first flag, among the plurality of pieces of the input data; and
a second sub-local counter configured to count the second flag and generate a second count value for a number of pieces of data associated with the second flag, among the plurality of pieces of the input data.

5. The data storage device of claim 4, wherein
the index generator generates the index based on the first count value and the second count value, and
the index comprises information on the number of pieces of data associated with the first flag included in the weight bundle and information on the number of pieces of data associated with the second flag included in the weight bundle.

6. The data storage device of claim 1, wherein
the memory controller further comprises a decompressor configured to perform a decompression operation on an output weight bundle read from the memory device, and
the decompressor comprises a flag decoder configured to decompress the first flag included in each piece in at least one piece of output data, among a plurality of pieces of output data included in the output weight bundle, into upper bits corresponding to the first flag.

7. The data storage device of claim 6, wherein
the flag decoder decompresses a first output flag included in first output data, among the plurality of pieces of the output data, into upper bits of the first output data, and then combines the upper bits of the first output data with lower bits of the first output data to generate third data.

8. The data storage device of claim 7, wherein
a size of the third data is larger than a size of the first output data.

9. The data storage device of claim 7, wherein
the flag decoder generates fourth data by omitting a second flag, included in second output data among the plurality of pieces of the output data, from the second output data.

10. The data storage device of claim 9, wherein
a size of the fourth data is smaller than a size of the second output data.

11. The data storage device of claim 10, wherein
the decompressor further comprises a second local counter configured to count the number of the first flags and a number of second flags, and
the second local counter comprises:
a third sub-local counter configured to count the number of the first flags and generate a first actual count value based on the number of pieces of output data associated with the first flag, among the plurality of pieces of the output data; and
a fourth sub-local counter configured to count the number of the second flags and generate a second actual count value based on the number of pieces of output data associated with the second flag, among the plurality of pieces of output data.

12. The data storage device of claim 11, wherein
the decompressor further comprises an index checker configured to receive an index included in the output weight bundle and, based on the index, obtain a first expected count value associated with the number of pieces of the output data associated with the first flag, among the plurality of pieces of the output data, and a second expected count value associated with the number of pieces of the output data associated with the second flag, among the plurality of pieces of the output data,
the index checker determines whether an error has occurred, based on a first comparison result between the first actual count value and the first expected count value and a second comparison result between the second actual count value and the second expected count value.

13. The data storage device of claim 11, wherein
the compressor further comprises a first global counter configured to manage a count value associated with a global block comprising a plurality of weight bundles, and
the first global counter comprises:
a first sub-global counter configured to receive the first count value from a first sub-local counter and generate a first global count value for a number of pieces of data associated with the first flag included in the global block; and
a second sub-global counter configured to receive a second count value from a second sub-local counter and generate a second global count value for a number of pieces of data associated with the second flag included in the global block.

14. The data storage device of claim 13, wherein
the decompressor further comprises a header generator configured to receive the first global count value and the second global count value from the first global counter and generate a header based on the first global count value and the second global count value.

15. The data storage device of claim 14, wherein
the decompressor further comprises a second global counter configured to manage a count value for an output global block comprising a plurality of output weight bundles, and
the second global counter comprises:
a third sub-global counter configured to receives the first actual count value from the third sub-local counter and generate a first actual global count value for the number of pieces of the data associated with the first flag included in the output global block; and
a fourth sub-global counter configured to receive the second actual count value from the fourth sub-local counter and generate a second actual global count value for the number of pieces of the data associated with the second flag included in the output global block.

16. The data storage device of claim 15, wherein
the decompressor further includes a header comparator configured to receive the header corresponding to the output global block and, based on the header, obtain a first expected global count value for the number of pieces of the data associated with the first flag included in the output global block and a second expected global count value for the number of pieces of the data associated with the second flag included in the output global block.

17. The data storage device of claim 16, wherein
the header comparator determines whether an error has occurred, based on a third comparison result between the first actual global count value and the first expected global count value and a fourth comparison result between the second actual global count value and the second expected global count value.

18. The data storage device of claim 1, wherein
the memory device further comprises an ECC engine configured to performs an error correction operation on data stored in the memory cells, and
an operation unit of the ECC engine and a write unit of the memory device are the same.

19. A memory controller controlling a memory device, the memory controller comprising:
a flag encoder configured to compress upper bits of each piece in at least one piece of input data, among a plurality of pieces of input data included in a weight bundle, into a first flag;
a first local counter configured to count a number of first flags and generates a first count value; and
an index generator configured to generate an index for the weight bundle based on the first count value.

20. A method of operating a data storage device, the method comprising:
compressing upper bits of each piece in at least one piece of input data, among a plurality of pieces of input data included in a weight bundle, into a first flag;
connecting a second flag to each piece in at least one piece of input data, among the plurality of pieces of input data in the weight bundle;
counting a number of first flags and generating a first count value;
counting a number of second flags and generating a second count value; and
generating an index comprising information on a number of pieces of input data compressed using the first flag, among the plurality of pieces of the input data included in the weight bundle, and information on a number of input data converted using the second flag, among the plurality of pieces of input data included in the weight bundle, based on the first count value and the second count value.
